(19) United States
(12) Patent Application Publication
(10) Pub. No.: US 2019/0113006 A1
(43) Pub. Date: Apr. 18, 2019

(54) Radiator-Less Liquid Cooling

(71) Applicant: Shawn Patrick Stockle, Medford, NY (US)

(72) Inventor: Shawn Patrick Stockle, Medford, NY (US)

(21) Appl. No.: 15/786,181

(22) Filed: Oct. 17, 2017

(51) Int. Cl. F02M 25/03; F02M 25/022; F01P 3/02

(52) U.S. Cl. CPC F02M 25/03; F02M 25/0221; F01P 2003/021; F02M 25/0227; F01P 3/02

(57) ABSTRACT

This invention is a simple method that would eliminate the need for a conventional liquid cooling system for an internal combustion engine with compression ignition (no spark plugs). It would replace the radiator, water pump, thermostat, etc. with computer controlled water injectors that fire directly into the combustion chamber(s). The engine control computer would control engine temperature by alternating the firing of the fuel and water injectors. Such an engine would be an internal combustion/steam engine hybrid when it reaches high temperatures.

### FIELD OF INVENTION

This invention relates to the manufacture of liquid cooled internal combustion engines with compression ignition (no spark plugs).

### BACKGROUND OF INVENTION

The modern method of liquid cooling an internal combustion engine was pioneered during and prior to the first world war. It involves the use of a radiator, water pump, thermostat, etc. to maintain proper engine temperature.

Modern engines have a thermal efficiency of only about 25-40%. “Radiator-Less Liquid Cooling” would significantly raise this number by utilizing what would normally be heat loss.

Many methods have been proposed to extract energy from steam from an internal combustion engine such as patents-U.S. Pat. Nos. 1,324,2183 3,921,404 4,122,803 4,300,353 4,301,655 4,322,950 4,377,934 4,402,182 4,406,127 4,433,548 4,509,464 4,590,766 4,706,462 5,000,003 5,010,852 5,191,766 5,896,746 6,095,100 6,202,782 6,986,252 8,061,140 8,109,097.

Most proposed methods for extracting energy from an internal combustion engine via steam pressure involve a mechanism for ducting steam to a turbine or a mechanism to alternate water and fuel into the combustion chambers. “Radiator-Less Liquid Cooling” differs in that it only requires fuel and water injectors that are computer controlled.

### SUMMARY OF INVENTION

“Radiator-Less Liquid Cooling” is a method to extract steam energy from an internal combustion engine by eliminating a conventional liquid cooling system and replacing it with computer controlled water injectors (1 for every cylinder) that fire directly into the combustion chambers. When the engine reaches high temperatures the engine control computer alternates the firing of the fuel and water injectors thus regulating temperature. Such an engine would have greater efficiency and reduced emissions.

1. “Radiator-Less Liquid Cooling” is a simple method to extract energy from an internal combustion engine by utilizing what would normally be heat loss. Such an engine would have no radiator, water pump, thermostat, etc. The engine temperature would be solely regulated by computer controlled water injectors that fire directly into the combustion chamber(s). The engine control computer would alternate the firing of the fuel and water injectors to regulate engine temperature.

2. Such an engine would be of compression ignition type (no spark plugs).

3. (canceled)

4. (canceled)

5. Such an engine would require a temperature sensor for every cylinder.

6. (canceled)
